(19) United States
(12) Patent Application Publication
(10) Pub. No.: US 2025/0299482 A1
(43) Pub. Date: Sep. 25, 2025

(54) CAMERA PERTURBATION EFFECT EVALUATION AND ELIMINATION METHOD, DEVICE AND STORAGE MEDIUM

(71) Applicants: SHENZHEN TECHNOLOGY INSTITUTE OF URBAN PUBLIC SAFETY, Shenzhen (CN); SHENZHEN SCIENCE AND TECHNOLOGY INSTITUTE OF URBAN SAFETY DEVELOPMENT, Shenzhen (CN)

(72) Inventors: Zhongqi SHI, Shenzhen (CN); Zhisen TAN, Shenzhen (CN); Nan JIN, Shenzhen (CN); Qingrui YUE, Shenzhen (CN); Hong FAN, Shenzhen (CN); Yanbing ZHOU, Shenzhen (CN)

(73) Assignees: SHENZHEN TECHNOLOGY INSTITUTE OF URBAN PUBLIC SAFETY, Shenzhen (CN); SHENZHEN SCIENCE AND TECHNOLOGY INSTITUTE OF URBAN SAFETY DEVELOPMENT, Shenzhen (CN)

(21) Appl. No.: 19/203,114

(22) Filed: May 8, 2025

Related U.S. Application Data
(63) Continuation of application No. PCT/CN2024/103683, filed on Jul. 4, 2024.

(30) Foreign Application Priority Data
Dec. 28, 2023 (CN) 202311829753.9

(51) Int. Cl. G06V 10/98

(52) U.S. Cl. CPC G06V 10/993

(57) ABSTRACT

Disclosed are a camera perturbation effect evaluation and elimination method, device and storage medium. The method includes: decomposing a signal to be processed and eliminating them one by one to generate a plurality of second signal sets, obtaining a plurality of frequency domain mirror indexes according to curve information obtained after frequency domain analysis of the plurality of second signal sets and a mirror index formula, determining a perturbation signal based on a maximum frequency domain mirror index, and eliminating the perturbation signal to obtain a perturbation elimination signal.

### CROSS-REFERENCE TO RELATED APPLICATIONS

This application is a continuation application of International Application No. PCT/CN2024/103683, filed on Jul. 4, 2024, which claims priority to Chinese Patent Application No. 202311829753.9, filed on Dec. 28, 2023. The disclosures of the above-mentioned applications are incorporated herein by reference in their entireties.

### TECHNICAL FIELD

The present application relates to the technical field of image processing, and in particular to a camera perturbation effect evaluation and elimination method, device and storage medium.

### BACKGROUND

In vision-based vibration measurement technology, cameras or sensors are used to capture the displacement information of the surface of an object under vibration to achieve vibration measurement. It has the advantages of high measurement accuracy, long monitoring distance, no need for direct contact with the measured object, and low monitoring cost. Compared with contact measurement methods, it has a wider application scenario and technical advantages. However, in the measurement application process, the vision-based vibration measurement technology will inevitably be disturbed by the vibration noise of the external environment, resulting in camera perturbations in the process of collecting image data, which in turn affects the accuracy of the structural vibration time history signal obtained based on image data analysis. Therefore, how to eliminate the camera perturbation effect has become a problem to be solved urgently.

The above content is only used to assist in understanding the technical solution of the present application, and does not mean that the above content is recognized as the related art.

### SUMMARY

The main purpose of the present application is to provide a camera perturbation effect evaluation and elimination method, device and storage medium, aiming to solve the technical problem of eliminating camera perturbation effects.

In order to achieve the above purpose, the present application provides a camera perturbation effect evaluation and elimination method, including:
decomposing a signal to be processed to obtain a first signal set, the signal to be processed is a signal obtained by analyzing a video captured by a camera;
selecting a different signal from the first signal set each time for elimination to obtain a plurality of second signal sets;
performing frequency domain analysis on the plurality of second signal sets to obtain a curve information set;
determining a frequency domain mirror index set based on curve information in the curve information set and a mirror index formula, the frequency domain mirror index set comprises a plurality of frequency domain mirror indexes, and each of the plurality of frequency domain mirror indexes corresponds to a signal eliminated from the first signal set; and
determining a maximum frequency domain mirror index from the plurality of frequency domain mirror indexes, determining a perturbation signal in the signal to be processed according to the maximum frequency domain mirror index, and eliminating the perturbation signal to obtain a perturbation elimination signal.

Besides, in order to achieve the above purpose, the present application also provides a camera perturbation effect evaluation and elimination device including a memory and a processor, a computer program is stored in the memory, and when the computer program is executed by the processor, the camera perturbation effect evaluation and elimination method described above is implemented.

Besides, in order to achieve the above purpose, the present application also provides a non-transitory computer-readable storage medium, a non-transitory computer program is stored in the computer-readable storage medium, and when the computer program is executed by a processor, the camera perturbation effect evaluation and elimination method described above is implemented.

The present application generates a plurality of second signal sets by decomposing the signal to be processed and then eliminating them one by one, and then obtains a plurality of frequency domain mirror indexes according to the curve information and mirror index formula obtained after frequency domain analysis of the plurality of second signal sets, and then determines the perturbation signal based on the maximum frequency domain mirror index, and eliminates the perturbation signal to obtain the perturbation elimination signal, thereby improving the accuracy of vibration measurement and achieving camera perturbation effect evaluation and elimination. The present application quantitatively evaluates the perturbation effect by determining the frequency domain mirror index, thereby determining the part of the vibration time history signal where the perturbation effect is severe, and eliminating this part to obtain an accurate vibration time history signal, thereby improving the accuracy of vibration measurement and realizing the evaluation and elimination of camera perturbation effects.

### BRIEF DESCRIPTION OF THE DRAWINGS

FIG. 1 is a schematic structural diagram of a camera perturbation effect evaluation and elimination device in the hardware operating environment according to an embodiment of the present application.

FIG. 2 is a schematic flow diagram of a camera perturbation effect evaluation and elimination method according to an embodiment of the present application.

FIG. 3 is a schematic sub-flow diagram of a camera perturbation effect evaluation and elimination method according to an embodiment of the present application.

FIG. 4 is another schematic sub-flow diagram of a camera perturbation effect evaluation and elimination method according to an embodiment of the present application.

FIG. 5 is another schematic sub-flow diagram of a camera perturbation effect evaluation and elimination method according to an embodiment of the present application.

FIG. 6 is a schematic sub-flow diagram of a camera perturbation effect evaluation and elimination method according to an embodiment of the present application.

FIG. 7 is a schematic sub-flow diagram of a camera perturbation effect evaluation and elimination method according to an embodiment of the present application.

FIG. 8 is a structural block diagram of a camera perturbation effect evaluation and elimination device according to an embodiment of the present application.

FIG. 9 is a schematic sub-flow diagram of a camera perturbation effect evaluation and elimination method according to an embodiment of the present application.

### DETAILED DESCRIPTION OF THE EMBODIMENTS

It should be understood that the specific embodiments described herein are only used to explain the present application and are not used to limit the present application.

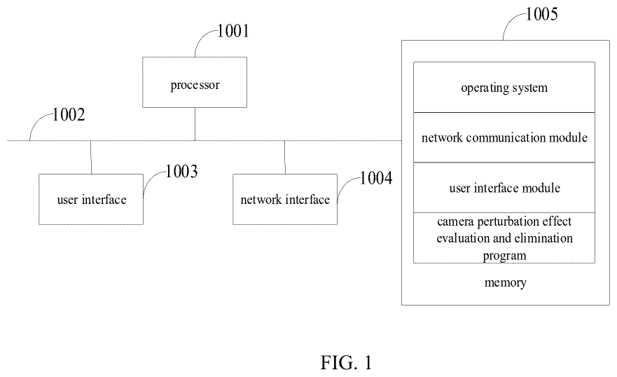

Referring to FIG. 1, FIG. 1 is a schematic structural diagram of a camera perturbation effect evaluation and elimination device in the hardware operating environment according to an embodiment of the present application.

As shown in FIG. 1, the camera perturbation effect evaluation and elimination device may include: a processor 1001, a communication bus 1002, a user interface 1003, a network interface 1004, and a memory 1005. The communication bus 1002 is used to realize the connection and communication between these components. The user interface 1003 may include a display and an input unit such as a keyboard, and the user interface 1003 may also include a standard wired interface and a wireless interface. The network interface 1004 may include a standard wired interface and a wireless interface. The memory 1005 may be a high-speed random access memory (RAM), a stable non-volatile memory (NVM), or a storage device independent of the aforementioned processor 1001.

Those skilled in the art can understand that the structure shown in FIG. 1 does not constitute a limitation on the camera perturbation effect evaluation and elimination device, and may include more or fewer components than shown in the figure, or combinations of certain components, or components arranged differently.

As shown in FIG. 1, the memory 1005 as a storage medium may include an operating system, a network communication module, a user interface module, and a camera perturbation effect evaluation and elimination program.

In the camera perturbation effect evaluation and elimination device shown in FIG. 1, the network interface 1004 is used to communicate data with a network server. The user interface 1003 is used to interact with the user. The processor 1001 and the memory 1005 in the camera perturbation effect evaluation and elimination device of the present application may be provided in the camera perturbation effect evaluation and elimination device, and the camera perturbation effect evaluation and elimination device calls the camera perturbation effect evaluation and elimination program stored in the memory 1005 through the processor 1001 to execute the camera perturbation effect evaluation and elimination method provided in the embodiment of the present application.

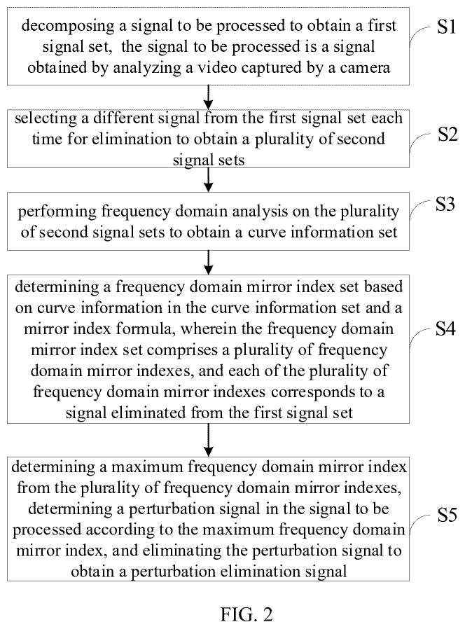

FIG. 2 is a schematic flow diagram of a camera perturbation effect evaluation and elimination method according to an embodiment of the present application. In this embodiment, the camera perturbation effect evaluation and elimination method includes the following steps.

Step S1, decomposing a signal to be processed to obtain a first signal set, the signal to be processed is a signal obtained by analyzing a video captured by a camera.

It should be noted that the execution subject of the method of this embodiment may be a computing service device with data processing, network communication and program running functions, such as a mobile phone, a tablet computer, a personal computer, etc., and may also be other electronic devices that can achieve the same or similar functions. Here, the camera perturbation effect evaluation and elimination device is used to specifically illustrate the camera perturbation effect evaluation and elimination method provided in this embodiment and the following embodiments.

The signal to be processed is a displacement time history signal obtained by performing displacement time history analysis on the measured object in the video after obtaining the video captured by the camera. The displacement time history analysis refers to recording and analyzing the relationship between the displacement of the measured object and time.

In an embodiment, before performing signal decomposition on the signal to be processed, first, obtaining the video captured by the camera, then performing displacement time history analysis on the captured video, and using analysis result as the signal to be processed. The principle of signal decomposition is to decompose a signal into a plurality of local functions, each of which corresponds to a frequency and an amplitude. The plurality of local functions obtained after the signal decomposition of the signal to be processed is used as a first signal set. Decomposing a displacement time history signal into a plurality of local functions makes the analysis of the displacement time history signal more accurate, which is conducive to the subsequent determination of the displacement caused by the camera perturbation and improves the effect of eliminating the camera perturbation effect.

In an embodiment, before performing signal decomposition on the signal to be processed, constructing an abnormal time history signal discrimination model trained by a large number of vibration time history signals, using the abnormal time-history signal discrimination model to discriminate the signal to be processed, eliminating abnormalities of the signal to be processed according to the processing result, and decomposing the signal to be processed after eliminating abnormalities to obtain the first signal set. By performing preliminary abnormality elimination on the signal to be processed, the accuracy of the subsequent curve information can be improved, and the frequency domain mirror index can be more accurate, thereby more accurately dividing the perturbation signal.

Step S2, selecting a different signal from the first signal set each time for elimination to obtain a plurality of second signal sets.

Step S3, performing frequency domain analysis on the plurality of second signal sets to obtain a curve information set.

First, the first signal in the first signal set is deleted, and the first signal set after the deletion of the signal is used as the second signal set. Second, the second signal in the first signal set is deleted, and the first signal set after the deletion of the signal is used as the second signal set. The above operation is repeated to obtain a plurality of second signal sets. It should be noted that there is no restriction on the order of deletion. It is only necessary to delete the signals that have not been deleted in the first signal set. For example, if the first signal of the first signal set is deleted for the first time to obtain the second signal set, the signal deleted for the second time can be any signal except the first signal of the first signal set, thereby obtaining another second signal set. In an embodiment, the number of second signal sets obtained depends on the number of signals in the first signal set, each signal in the first signal set corresponds to a deletion operation performed, thereby obtaining the same number of second signal sets.

The frequency domain analysis is performed on each second signal set by formula 1, and the formula 1 is:

$$f ( i ) = {\sum }_{t = 0}^{N - 1} x ( t ) {e}^{- i \frac{2 π}{N} kt}$$

Where x(t) is a vibration time history signal of the tth time domain discrete point, i is a frequency domain discrete point signal corresponding to t, N is a time domain length of the signal; and f(k) is a frequency domain vector of the structural vibration time history signal.

A time domain signal in the second signal set is converted into a frequency domain signal by formula 1, that is, the signal in the second signal set is decomposed into a series of sine waves of different frequencies to represent the characteristics of the signal in the frequency domain. In an embodiment, the time domain signal can be represented as a sum of a series of complex numbers by formula 1, each complex number represents the amplitude and phase of a sine wave of different frequencies, and these complex numbers are the frequency domain representation of the signal.

The signal in the second signal set may represent a synthesis of sinusoidal signals of different frequencies. The mathematical model of the relationship between the steady-state output and input signal of the signal in the second signal set under the sinusoidal function at different frequencies acts is a frequency characteristic, which is a complex ratio of the frequency response of the second signal set to the sinusoidal input signal when performing frequency domain transformation on the second signal set. The second signal set may be linearly studied according to the frequency characteristic. Performing frequency domain analysis on the plurality of second signal sets is to calculate a proportion of sinusoidal waves of various frequencies in the signal.

In an embodiment, when performing frequency domain analysis on the second signal set, some sinusoidal wave components with relatively large amplitudes may also be retained for future signal recovery. This has many advantages in practical applications, such as reducing the data required to represent the signal, saving memory for storing data, saving time for transmitting data, and increasing the efficiency of communication lines. By performing frequency-domain analysis on the plurality of second signal sets, the plurality of second signal sets are analyzed from the perspective of frequency, curve information sets are generated after obtaining a plurality of frequency spectra, and dynamic analysis of the plurality of second signal sets is realized, which is conducive to finding the part with large camera perturbation effect in the signal, and improving the accuracy and effect of camera perturbation effect evaluation and elimination.
S4, determining a frequency domain mirror index set based on curve information in the curve information set and a mirror index formula, the frequency domain mirror index set includes a plurality of frequency domain mirror indexes, and each of the plurality of frequency domain mirror indexes corresponds to a signal eliminated from the first signal set. The mirror index formula is:

$${K}_{k} = ( \frac{\vert {f}^{″} ( i ) \vert \cdot \vert {F}^{″} ( i ) \vert}{{( 1 + {( {f}^{′} ( i ) )}^{2} )}^{3 / 2} \cdot {( 1 + {( {F}^{′} ( i ) )}^{2} )}^{3 / 2}} \cdot \frac{{σ}_{f} {σ}_{F}}{[ f ( i ) - \overline{f ( i )} ] [ F ( i ) - \overline{F ( i )} ]} ) \times \sqrt{\frac{{\sum }_{i = 1}^{n} ( f ( i ) - F ( i ) )}{{\sum }_{i = 1}^{n} {( F ( i ) )}^{2}}} ,$$

where • represents vector point multiplication operation, |•| represents absolute value operation, X represents multiplication numerical operation; σ_{f} and σ_{F} respectively represent the standard deviation of f(i) and the standard deviation of F(i); f̅(̅i̅)̅ and F̅(̅i̅)̅ respectively represent the average values of f(i) and F(i), and Kk represents the frequency domain mirror index for removing the kth order modal signal.

The curve information set includes a plurality of curves, and the curve information includes a curve amplitude, a curve shape and a curvature radius of the curve. According to the curve amplitude, curve shape and curvature radius of each curve, a frequency domain mirror index is obtained, which can be used to evaluate and quantify the perturbation effect of the second signal set corresponding to the curve compared with the signal missing from the first signal set (the second signal set is generated by removing the signal from the first signal set). Then, according to the curve amplitude, curve shape and curvature radius of the plurality of curves, a plurality of frequency domain mirror indexes are obtained to realize the evaluation and quantification of the perturbation effect of each signal in the first signal set.

In the above steps, the number of second signal sets is the same as the number of signals included in the first signal set. Since each second signal set corresponds to a curve, the number of frequency domain mirror indexes in the frequency domain mirror index set is also the same as the number of signals included in the first signal set, and each frequency domain mirror index corresponds to a signal in the first signal set.

In an embodiment, the frequency domain mirror index set is determined according to the curve information in the curve information set, so that the perturbation effect of the signal is evaluated and quantified, which is convenient for the subsequent optimization of the perturbation effect and improves the accuracy and efficiency of the camera perturbation effect evaluation and elimination.
S5, determining a maximum frequency domain mirror index from the plurality of frequency domain mirror indexes, determining a perturbation signal in the signal to be processed according to the maximum frequency domain mirror index, and eliminating the perturbation signal to obtain a perturbation elimination signal.

The maximum frequency domain mirror index is a maximum value among a plurality of frequency domain mirror indexes. First, the maximum value among the plurality of frequency domain mirror indexes is determined, and a range to be eliminated is determined according to a preset order data. It should be noted that the preset order data is a numerical value set artificially according to different requirements, and the range to be eliminated refers to the part to be eliminated as a perturbation signal under different requirements, that is, the perturbation signal. For example, if the preset order data is 10, the signal corresponding to the maximum frequency domain mirror index and all signals of the 10 orders before the signal corresponding to the maximum frequency domain mirror index are used as perturbation signals and eliminated to obtain a perturbation elimination signal. Within a certain range, the larger the preset order data, the larger the range to be eliminated, that is, the better the effect of perturbation elimination. It should be understood that the preset order data cannot exceed the order of the signal to be processed to avoid complete elimination.

In an embodiment, the perturbation signal is eliminated according to formula 2, and the formula 2 is:

$${x}^{′} ( t ) \approx x ( t ) - \sum {u}_{s} ( t ) {e}^{i ω st} ,$$

where x′(t) is the obtained perturbation elimination signal, x(t) is the signal to be processed, uₛ(t) is the signal corresponding to the maximum frequency domain mirror index, s is the preset order data, and t is time.

Most of the perturbations of the camera are caused by the interference of vibration noise in the external environment. It is difficult to identify the perturbation effect through the human eye. The perturbation effect is quantified by the frequency domain mirror index, so that the area where the perturbation effect exists in the signal can be accurately found, which improves the accuracy and efficiency of the camera perturbation effect evaluation and elimination.

The present application generates a plurality of second signal sets by decomposing the signals to be processed and then eliminating them one by one, obtains a plurality of frequency domain mirror indexes based on the curve information and mirror index formula obtained after frequency domain analysis of the plurality of second signal sets, determines the perturbation signal based on the maximum frequency domain mirror index, and eliminates the perturbation signal to obtain the perturbation elimination signal, thereby improving the accuracy of vibration measurement and realizing the camera perturbation effect evaluation and elimination. The present application quantitatively evaluates the perturbation effect by determining the frequency domain mirror index, thereby determining the part of the vibration time history signal with severe disturbance effect, and eliminating the part, thereby obtaining an accurate vibration time history signal, improving the accuracy of vibration measurement, and realizing the elimination of camera perturbation effect.

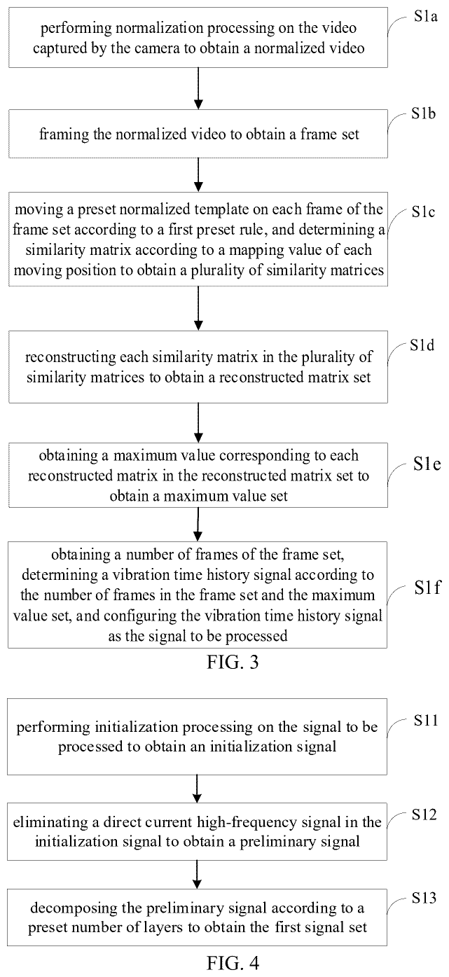

Please refer to FIG. 3, FIG. 3 is a schematic sub-flow diagram of a camera perturbation effect evaluation and elimination method according to an embodiment of the present application.

Based on the above embodiment, in this embodiment, before the step S1, the method further includes:
S1a, performing normalization processing on the video captured by the camera to obtain a normalized video; and
S1b, framing the normalized video to obtain a frame set.

The normalization refers to a way of simplifying calculations, that is, transforming a dimensional expression into a dimensionless expression to become a scalar. After normalization, incomparable data can be made comparable while maintaining the relative relationship between the two compared data. The preset normalized template is obtained by normalizing the acceleration template. The acceleration template is obtained by extracting the surface area of the pasting after pasting an accelerometer on the captured object, and is used to track the video captured by the camera.

In an embodiment, the normalization processing is performed on the video captured by the camera and the acceleration template by Formula 3 and Formula 4 respectively. The above formula 3 is:

$${T}^{′} ( x , y ) = \frac{T ( x , y ) - \frac{1}{{w}_{1} \times {h}_{1}} {\sum }_{x , y} T ( x , y )}{\sqrt{{\sum }_{x , y} {T ( x , y )}^{2}}} ,$$

The above formula 4 is:

$${I}^{′} ( x , y ) = \frac{I ( x , y ) - \frac{1}{{w}_{2} \times {h}_{2}} {\sum }_{x , y} I ( x , y )}{\sqrt{{\sum }_{x , y} {I ( x , y )}^{2}}}$$

Where w1 and h1 are the length and width of the acceleration template, w2 and h2 are the length and width of the video captured by the camera, T and I are the normalized template and the video captured by the camera, T′ and I′ are the normalized template and the video captured by the camera. It should be understood that videos are composed of frames, and the video to be processed is actually composed of a plurality of frames, which are framed to obtain a frame set.

By performing normalization processing on the video captured by the camera and the acceleration template, the dimensional influence of the two is eliminated, the data complexity is reduced, and the data visualization effect is improved, thereby improving the accuracy and efficiency of subsequent camera perturbation effect evaluation and elimination.
S1c, moving a preset normalized template on each frame of the frame set according to a first preset rule, and determining a similarity matrix according to a mapping value of each moving position to obtain a plurality of similarity matrices.

The first preset rule is to move from a vertex of each frame and cling to the frame in either a clockwise or counterclockwise direction until the entire frame is traversed. It should be noted that the order of movement can be from left to right, from top to bottom, or from left to right, from bottom to top, and no specific limitation is made here.

In an embodiment, a distance of each movement is one pixel, and the mapping value is a value of a position on the frame after each movement. After the normalized template moves through a frame, the similarity matrix is calculated by formula 5. Since there are a plurality of frames, a similarity matrix set is obtained. It should be understood that since a similarity matrix is obtained after each movement through a frame, the number of similarity matrices is the same as the number of frame sets. The above formula 5 is:

$$R ( x , y ) = \frac{{\sum }_{{x}^{′} , {y}^{′}} ( {T}^{′} ( {x}^{′} , {y}^{′} ) {I}^{′} ( x + {x}^{′} , y + {y}^{′} ) )}{\sqrt{{\sum }_{{x}^{′} , {y}^{′}} {{T}^{′} ( {x}^{′} , {y}^{′} )}^{2} {\sum }_{{x}^{′} , {y}^{′}} {{I}^{′} ( x + {x}^{′} , y + {y}^{′} )}^{2}}} ,$$

Where (x, y) is a coordinate of a point on the normalized frame (normalized frame is obtained after normalized video is framed); (x′, y′) is a normalized template coordinate, T(x, y) is a normalized template, and the normalized template is w×h in size; a point (x, y) on the similarity matrix R(x, y) represents a correlation between the image sub-block with (x, y) as the upper left corner point in the normalized frame I′ and the same size as the template image T(x, y) and T(x, y).
S1d, reconstructing each similarity matrix in the plurality of similarity matrices to obtain a reconstructed matrix set; and
S1e, obtaining a maximum value corresponding to each reconstructed matrix in the reconstructed matrix set to obtain a maximum value set.

The coordinates (x, y) are decomposed into the integer part x0, y0 and the decimal part dx, dy, and the following relationship holds:

$$x = {x}_{0} + dx$$

$$y = {y}_{0} + dy$$

Then taking 16 adjacent pixels centered at (x0, y0) and marking them as I (xi, yi), where i, j=0, 1, 2, 3;

Then the similarity matrix is reconstructed according to formula 6, and the formula 6 is:

$${R}^{′} ( x , y ) = {\sum }_{i = 0}^{3} {\sum }_{j = 0}^{3} R ( x , y ) H ( i - dx ) H ( dy - j )$$

$$Where , H ( t ) = \{ \begin{matrix}( a + 2 ) {\vert t \vert}^{3} - ( a + 3 ) {\vert t \vert}^{2} + 1 & , & 0 \leq \vert t \vert < 1 \\ a {\vert t \vert}^{3} - 5 a {\vert t \vert}^{2} + 8 a \vert t \vert - 4 a & , & 1 \leq \vert t \vert < 2 \\ 0 & , & \vert t \vert \geq 2\end{matrix} .$$

In an embodiment, a maximum value corresponding to each reconstruction matrix is a maximum value of the position index of the reconstruction matrix, which can be represented by (x, y). Since each reconstruction matrix has a maximum value, a maximum value set is obtained, and the number of maximum values in the maximum value set is the same as the number of reconstruction matrices and the number of similar matrices.

By reconstructing the similarity matrix, the video with perturbation effects is screened, so that the subsequent camera perturbation effect evaluation and elimination effect is better.
S1f, obtaining a number of frames of the frame set, determining a vibration time history signal according to the number of frames in the frame set and the maximum value set, and configuring the vibration time history signal as the signal to be processed.

The vibration time course signal is obtained by formula 7, and formula 7 is:

$$\{ \begin{matrix}Δ {H}_{i} = {H}_{i + 1} - {H}_{i} \\ Δ {L}_{i} = {L}_{i + 1} - {L}_{i}\end{matrix} , i = 1 , 2 , ... ( n - 1 )$$

Where n is a number of image frames, Hi and Li are a width position and a height position of the maximum value of the image mapping value of the i-th frame, respectively.

By calculating the vibration time history signal, it is convenient to perform vibration analysis on the captured object, and then eliminate the perturbation effect of the camera, thereby improving the efficiency and effect of the camera perturbation effect evaluation and elimination.

Please refer to FIG. 4, FIG. 4 is another schematic sub-flow diagram of a camera perturbation effect evaluation and elimination method according to an embodiment of the present application.

Based on the above embodiment, in this embodiment, the step S1 includes:
S11, performing initialization processing on the signal to be processed to obtain an initialization signal;
S12, eliminating a direct current high-frequency signal in the initialization signal to obtain a preliminary signal; and
S13, decomposing the preliminary signal according to a preset number of layers to obtain the first signal set.

The initialization processing refers to decomposing the signal to be processed into multi-order modal signals and multi-order modal frequencies. It should be noted that the specific means of the initialization process can be Fourier transform or wavelet transform of the signal to be processed, which is not specifically limited here.

The obtained multi-order modal signals and abnormal signals (direct current high-frequency signals) in the multi-order modal frequencies are eliminated to obtain an initial signal, thereby improving the accuracy of the obtained signal. The preset number of layers is a number of layers set for stratification, which can be set according to different displacement time course signals. The preliminary signal is decomposed according to the preset number of layers, which improves the accuracy of determining various characteristics of the signal, and is conducive to the subsequent elimination of the camera perturbation effect.

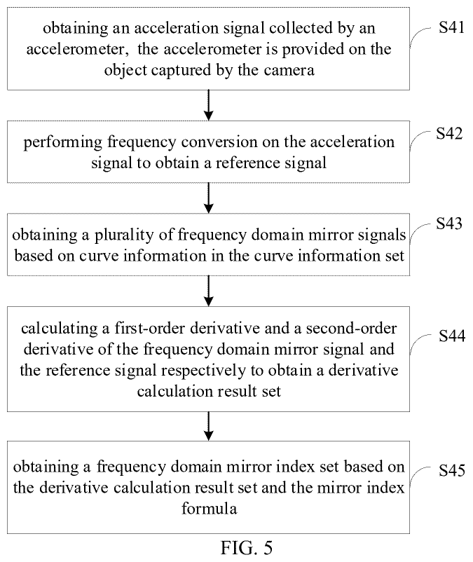

Please refer to FIG. 5, FIG. 5 is another schematic sub-flow diagram of a camera perturbation effect evaluation and elimination method according to an embodiment of the present application.

Based on the above embodiment, in this embodiment, the step S4 includes:
S41, obtaining an acceleration signal collected by an accelerometer, the accelerometer is provided on the object captured by the camera; and
S42, performing frequency conversion on the acceleration signal to obtain a reference signal.

When the camera captures a video, the accelerometer is attached to the object captured, and the acceleration time course signal (acceleration signal) is obtained by analyzing the data obtained by the accelerometer. It should be noted that the accelerometer starts to collect data when the video starts shooting, and the two are synchronized.

The frequency domain transformation is performed on the acceleration signal by formula 8, and the formula 8 is:

$$F ( i ) = {\sum }_{t = 0}^{N - 1} a ( t ) {e}^{- i \frac{2 π}{N} k t}$$

Where a(t) is the acceleration signal of the tth time domain, i is the frequency domain signal corresponding to t, and N is the time domain length of the signal.

The signal obtained after the acceleration signal is transformed into the frequency domain is used as a reference signal for subsequent comparison of the perturbation effect and the perturbation elimination effect, thereby improving the efficiency of the camera perturbation effect evaluation and elimination.
S43, obtaining a plurality of frequency domain mirror signals based on the curve information in the curve information set;
S44, calculating a first-order derivative and a second-order derivative of the frequency domain mirror signal and the reference signal respectively to obtain a derivative calculation result set; and
S45, obtaining a frequency domain mirror index set based on the derivative calculation result set and the mirror index formula.

The frequency domain mirror signal is obtained according to the curve information (curve amplitude, curve shape and curvature radius) in the curve information set. Then, calculating the first-order derivative and the second-order derivative of the frequency domain mirror signal and the reference signal respectively. The first-order derivative and second-order derivative of the frequency domain image signal are calculated as f′ (i) and f″ (i), respectively, and the first-order derivative and second-order derivative of the reference signal are calculated as F(i) and F″ (i), respectively. Then, calculating the frequency domain image index according to formula 9 (Image Index Formula), and the formula 9 is:

$${K}_{k} = ( \frac{\vert {f}^{″} ( i ) \vert \cdot \vert {F}^{″} ( i ) \vert}{{( 1 + {( {f}^{′} ( i ) )}^{2} )}^{3 / 2} \cdot {( 1 + {( {F}^{′} ( i ) )}^{2} )}^{3 / 2}} \cdot \frac{{σ}_{f} {σ}_{F}}{[ f ( i ) - \overline{f ( i )} ] [ F ( i ) - \overline{F ( i )} ]} ) \times \sqrt{\frac{{\sum }_{i = 1}^{n} ( f ( i ) - F ( i ) )}{{\sum }_{i = 1}^{n} {( F ( i ) )}^{2}}}$$

where • represents vector dot multiplication operation, |•| represents absolute value operation, and X represents multiplication numerical operation; Of and OF represent the standard deviation of the frequency domain mirror signal f(i) and the standard deviation of the reference signal F(i) respectively; and f̅(̅i̅)̅ and F̅(̅i̅)̅ represent the average values of f(i) and F(i) respectively, and Kk represents the frequency domain mirror index for removing the k-th order modal signal.

Through the frequency domain mirror index, the perturbation effect can be quantitatively evaluated, avoiding human subjective judgment, reducing errors, and thus improving the effect of camera perturbation effect evaluation and elimination.

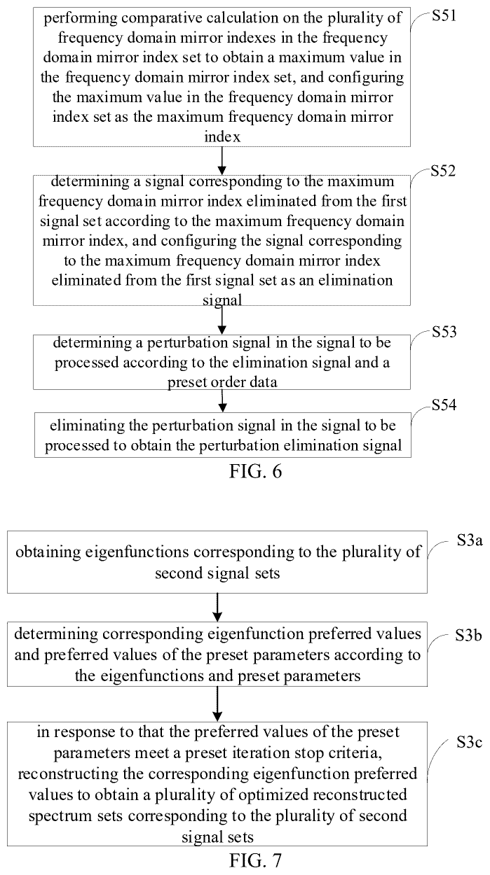

Please refer to FIG. 6, FIG. 6 is a schematic sub-flow diagram of a camera perturbation effect evaluation and elimination method according to an embodiment of the present application. Based on the above embodiment, in this embodiment, the step S5 includes:
S51, performing comparative calculation on the plurality of frequency domain mirror indexes in the frequency domain mirror index set to obtain a maximum value in the frequency domain mirror index set, and configuring the maximum value in the frequency domain mirror index set as the maximum frequency domain mirror index;
S52, determining a signal corresponding to the maximum frequency domain mirror index eliminated from the first signal set according to the maximum frequency domain mirror index, and configuring the signal corresponding to the maximum frequency domain mirror index eliminated from the first signal set as an elimination signal;
S53, determining a perturbation signal in the signal to be processed according to the elimination signal and a preset order data; and
S54, eliminating the perturbation signal in the signal to be processed to obtain the perturbation elimination signal.

Individual frequency domain mirror indexes in the frequency domain mirror index set are compared to obtain the frequency domain mirror index with the largest value, and the frequency domain mirror index with the largest value is used as the maximum frequency domain mirror index, indicating that the corresponding signal position has a largest perturbation effect. In the above embodiment, it is known that each frequency domain mirror index corresponds to the signal eliminated from the first index set, and the signal corresponding to the maximum frequency domain mirror index eliminated from the first index set is obtained accordingly. It should be noted that if the perturbation effect is to be eliminated, the point where the perturbation effect is the largest must be eliminated. Therefore, the signal eliminated by the first index set is used as the elimination signal, and the elimination range is determined according to the preset order data. In simple terms, the signal eliminated by the first index set is used as an endpoint, and another endpoint is determined according to the preset order data. The obtained signal is used as the perturbation signal, and the perturbation signal is eliminated from the signal to be processed, thereby obtaining the perturbation elimination signal. The step of eliminating the perturbation signal can be expressed by formula 10:

$${x}^{′} ( t ) \approx x ( t ) - \sum {u}_{s} ( t ) {e}^{i ω s t}$$

Where, x′(t) is the obtained perturbation elimination signal, x(t) is the signal to be processed, and Σuₛ(t)e^{iωt} is the perturbation signal.

The position where the perturbation effect is most serious is determined by the maximum frequency domain image index, and based on the continuity of the signal, the elimination range is determined according to the preset order data, so as to obtain the perturbation elimination signal after the perturbation is eliminated, and to obtain an accurate vibration time history signal, thereby eliminating and reducing the influence of the camera perturbation effect on the vibration measurement.

Please refer to FIG. 7, FIG. 7 is a schematic sub-flow diagram of a camera perturbation effect evaluation and elimination method according to an embodiment of the present application.

Based on the above embodiments, in this embodiment, before the step S3, the method further includes:
S3b, determining corresponding eigenfunction preferred values and preferred values of the preset parameters according to the eigenfunctions and preset parameters; and
S3a, obtaining eigenfunctions corresponding to the plurality of second signal sets;
S3c, in response to that the preferred values of the preset parameters meet a preset iteration stop criteria, reconstructing the corresponding eigenfunction preferred values to obtain a plurality of optimized reconstructed spectrum sets corresponding to the plurality of second signal sets.

Step S3b includes:
S3b1, dividing the preset parameters into eigenfrequency and regularization parameters;
S3b2, constructing an optimization formula based on the eigenfunction, the eigenfrequency and the regularization parameters; the optimization formula is:

$$min {\sum }_{k = 1}^{K} \frac{{α}_{k}}{2} {‖ x ( t ) - {\sum }_{k = 1}^{K} {u}_{k} ( t ) {e}^{{iω}_{k} t} ‖}^{2} ,$$

where uₖ(t) is a Kth eigenfunction, ωₖ is a Kth eigenfrequency, αₖ(t) is a Kth regularization parameter, t is time, K is the number of eigenfunctions, and x(t) is the signal to be processed.
S3b3, fixing the eigenfunction and the regularization parameter, and taking a partial derivative of the eigenfrequency according to the optimization formula to obtain an optimal value of the eigenfrequency;
S3b4, fixing the regularization parameter and the eigenfrequency, taking a partial derivative of the eigenfunction according to the optimization formula to obtain an optimal value of the eigenfunction, and updating the optimal value of the eigenfunction to the optimization formula; and
S3b5, fixing the eigenfunction and the eigenfrequency, and taking a partial derivative of the regularization parameter according to the optimization formula to obtain an optimal value of the regularization parameter.

Regularization parameters include regularization parameters and Lagrange multiplier parameters, setting regularization parameters α₁, α₂, . . . , αₖ, mode number K, Lagrange multiplier parameters λ₁, λ₂, . . . , λₖ, camera frame rate fps and preset iteration standard Δε, k eigenfunctions are μᵤ(t) . . . , μₖ(t), and k eigenfrequencies are ω1, . . . , ωk. An optimization formula is created based on the above parameters:

$$min {\sum }_{k = 1}^{K} \frac{{α}_{k}}{2} {‖ x ( t ) - {\sum }_{k = 1}^{K} {u}_{k} ( t ) {e}^{iωkt} ‖}^{2}$$

Where uk(t) is the Kth eigenfunction, ωk is the Kth eigenfrequency, αk(t) is the Kth regularization parameter, t is time, K is the number of eigenfunctions, and x(t) is the signal to be processed.

Then, iterative calculation is performed according to the following order:
(1) Fixing uₖ(t) and αₖ, and taking a partial derivative of the optimization formula with respect to ωₖ to obtain an optimal ωₖ.
(2) Fixing αₖ and ωₖ, and taking a partial derivative of the optimization formula with respect to uₖ(t) to obtain an optimal uₖ(t), and updating uₖ(t).
(3) Fixing uₖ(t) and ωₖ, and taking a partial derivative of the optimization formula with respect to αₖ to obtain an optimal αₖ, and updating αₖ.
(4) Fixing uₖ(t) and αₖ and taking a partial derivative of the optimization formula with respect to ωₖ, and updating ωₖ.
(5) Checking whether the following preset iteration stopping criteria are met:

$$min {\sum }_{k = 1}^{K} \frac{{α}_{k}}{2} {‖ x ( t ) - {\sum }_{k = 1}^{K} {u}_{k} ( t ) {e}^{iωkt} ‖}^{2} \leq Δ ε$$

If satisfied, stop the iteration, otherwise continue to iterate and calculate the above steps (2) (3) (4), and output the optimal μ₁(t), . . . , μₖ(t).

Formula 11 is used to reconstruct the corresponding eigenfunction optimal value to obtain the optimized reconstructed spectrum set corresponding to the plurality of second signal sets. The formula 11 is:

$$x ( t ) \approx {\sum }_{k = 2}^{K} {u}_{k} ( t ) {e}^{iωkt}$$

On the basis of the above embodiment, before performing frequency domain analysis on the plurality of second signal sets to obtain the curve information set, by determining the preferred values of the signal eigenfunction and the preset parameters in the first signal set, the second signal set is made more accurate, and the effect of subsequent camera perturbation effect evaluation and elimination is improved. According to the optimization formula and the method of partial derivative, the efficiency of camera perturbation effect evaluation and elimination is improved, and processing time is saved.

In an embodiment, step 1, setting parameter change restriction conditions, introspection parameters c, recombination period T, population size m, matrix row number M, set iteration termination conditions, including: setting a maximum number of iterations genmax, setting iteration loop termination conditions: including a maximum number of modalities Kmax and a preset order data s.

Step 2, entering a loop from K=2, initializing and generating an array A with a fixed number of rows of M and a number of columns of 2K+2, the array A includes: columns 1 to K represent randomly generated regularization parameters α₁, α₂, . . . , αₖ, columns K+1 to 2K represent randomly generated Lagrange multiplier parameters λ₁, λ₂, . . . , λₖ, the 2K+1 column represents the generated positive integer preset order data, and the 2K+2 column represents the frequency domain mirror index Kk.

Step 3, for each row in the A matrix, based on the first 2K+1 column parameters, calculating a frequency domain mirror index according to the method provided in the above embodiment, and outputting a maximum frequency domain mirror index as a value of the 2K+2 column of a corresponding row.

Step 4, taking every m rows in matrix A as a group of population data, and selecting a row vector corresponding to the maximum index Kk in the 2K+2 column in each population group as the optimal parameter Gibest(j) of the matrix; i represents a sequence number of the population, i=1, 2, . . . , (M/m); j represents a 2K+1 parameters in matrix A.

Step 5, updating a parameters of matrix A based on the optimal parameters obtained in the above steps and the set introspection parameter c, generating an updated matrix A′, and calculating a Kk index value of the 2K+2 column in each row based on the above steps.

Step 6, comparing the Kk index of each row in matrix A and matrix A′, selecting a corresponding rows of data with large Kk index to form matrix A″, selecting a row vector corresponding to the maximum index Kk in each group data of matrix A″ as the optimal parameter Gibest (j)′ of the group, and selecting the global optimal parameter Gbest in the optimal parameter column.

Step 7, obtaining matrix A′″ by randomly updating matrix A″ based on the optimal parameter column. First, determining whether the iteration termination condition is met, and then determining whether the loop termination condition is met: if the iteration termination condition is met: the number of iterations is greater than or equal to genmax, a row of parameter vectors corresponding to the maximum value of the current Kk index is output, otherwise execute step 8; if the iteration termination condition is met, further determining whether the loop termination condition is met. If the loop termination condition is met: K>Kmax, terminating the calculation, otherwise let K=K+1.

Step 8, shuffling randomly the matrix A″ when the number of iterations is an integer a plurality of the set recombination period T, and re-executing steps 3-7.

In an embodiment, in the process of updating parameters in step 1 to step 5, the optimization parameter restriction condition is met.

In an embodiment, the formula for updating the 2K+1 column parameters of matrix A in step 5 is:

$${A}_{ij}^{′} = c * {A}_{ij} + r * ( {Gi}_{best} ( j ) - \cdot {A}_{ij} ) ;$$

Where i=1, 2, . . . , (M/m); j=1, 2, . . . , 2K+1, Aᵢⱼ and Aᵢⱼ′ respectively represent the values of the parameters of the i-th row and j-th column in the matrix A and the matrix A′, and r represents a random number in the range of 0 to 1.

In an embodiment, in step 7, the matrix A″ is obtained by randomly updating A″ based on the optimal parameter column;

Where the formula for updating the 2K+1 column parameters of the matrix A″ is:

$${A}_{ij}^{′′′} = {A}_{ij}^{″} + r 1 \times ( {Gr}_{best} - {A}_{ij}^{″} ) + r 2 \times ( {G}_{best} - {A}_{ij}^{″} ) + r 3 \times ( {A}_{kj}^{″} - {A}_{ij}^{″} ) ;$$

Aᵢⱼ″ and Aᵢⱼ′″ represent the values of the parameters of the i-th row and j-th column in the matrix A″ and the matrix A″ respectively; i=1, 2, . . . , (M/m); j=1, 2, . . . , 2K+1, r1, r2, r3∈rand(0,1). In an embodiment, after step 8, the method further includes:
step 9, according to the first 2K columns of the output optimal parameter vector, based on the method provided in the above embodiment of the present application, obtaining the first s-order mode U(t) with the largest frequency domain mirror index, and eliminating the first s-order mode U(t) from the original structural vibration time history signal (signal to be processed).

On the basis of the above embodiment, through the above preferred steps, when obtaining the frequency domain mirror index, the time for obtaining the optimal value of the parameter is saved, the efficiency of obtaining the optimal value of the parameter is improved, and the efficiency of camera perturbation effect evaluation and elimination is improved.

In addition, the embodiment of the present application also provides a storage medium, a camera perturbation effect evaluation and elimination program is stored in the storage medium, and when the camera perturbation effect evaluation and elimination program is executed by the processor, the steps of the camera perturbation effect evaluation and elimination method as described above are implemented.

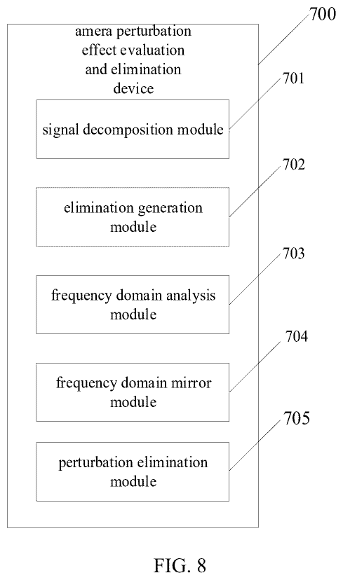

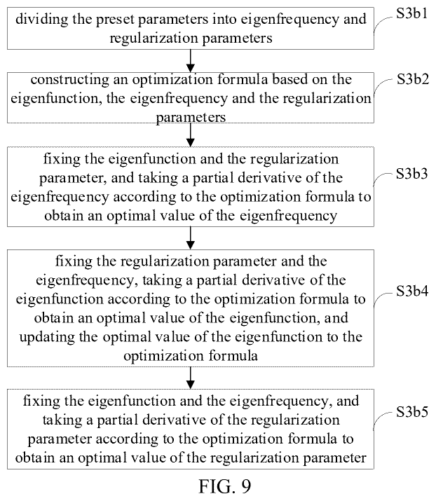

Referring to FIG. 8, FIG. 8 is a structural block diagram of a camera perturbation effect evaluation and elimination device according to an embodiment of the present application.

The camera perturbation effect evaluation and elimination device 700 includes a signal decomposition module 701, an elimination generation module 702, a frequency domain analysis module 703, a frequency domain mirror module 704 and a perturbation elimination module 705.

The signal decomposition module 701 is configured to decompose a signal to be processed to obtain a first signal set, the signal to be processed is a signal obtained by analyzing a video captured by a camera.

The elimination generation module 702 is configured to select a different signal from the first signal set each time for elimination to obtain a plurality of second signal sets.

The frequency domain analysis module 703 is configured to perform frequency domain analysis on the plurality of second signal sets to obtain a curve information set.

The frequency domain mirror module 704 is configured to determine a frequency domain mirror index set based on a curve information in the curve information set and a mirror index formula, the frequency domain mirror index set comprises a plurality of frequency domain mirror indexes, and each of the plurality of frequency domain mirror indexes corresponds to a signal eliminated from the first signal set.

The perturbation elimination module 705 is configured to determine a maximum frequency domain mirror index from the plurality of frequency domain mirror indexes, determine a perturbation signal in the signal to be processed according to the maximum frequency domain mirror index, and eliminate the perturbation signal to obtain a perturbation elimination signal.

The signal decomposition module 701 includes: an initialization unit configured to perform initialization processing on the signal to be processed to obtain an initialization signal; a elimination unit configured to eliminate a direct current high-frequency signal in the initialization signal to obtain a preliminary signal; and a preset decomposition unit configured to decompose the preliminary signal according to a preset number of layers to obtain the first signal set.

The frequency domain mirror module 704 includes: an acceleration unit configured to obtain an acceleration signal collected by an accelerometer, the accelerometer is provided on the object captured by the camera; a frequency domain conversion unit configured to perform frequency conversion on the acceleration signal to obtain a reference signal; a mirror acquisition unit configured to obtain a plurality of frequency domain mirror signals based on the curve information in the curve information set; a derivative calculation unit configured to calculate a first-order derivative and a second-order derivative of the frequency domain mirror signal and the reference signal respectively to obtain a derivative calculation result set; and a mirror index unit configured to obtain a frequency domain mirror index set based on the derivative calculation result set and the mirror index formula.

The perturbation elimination module 705 includes: a maximum frequency domain unit, configured to perform comparative calculation on the plurality of frequency domain mirror indexes in the frequency domain mirror index set to obtain a maximum value in the frequency domain mirror index set, and use the maximum value in the frequency domain mirror index set as the maximum frequency domain mirror index; a corresponding elimination unit, configured to determine a signal corresponding to the maximum frequency domain mirror index eliminated from the first signal set according to the maximum frequency domain mirror index, and use the signal corresponding to the maximum frequency domain mirror index eliminated from the first signal set as an elimination signal; a perturbation signal unit, configured to determine a perturbation signal in the signal to be processed according to the elimination signal and a preset order data; and a perturbation elimination unit, configured to eliminate the perturbation signal in the signal to be processed to obtain the perturbation elimination signal.

This embodiment generates a plurality of second signal sets by decomposing the signal to be processed and then eliminating them one by one, then obtains a plurality of frequency domain mirror indexes based on the curve information and mirror index formula obtained after frequency domain analysis of the plurality of second signal sets, and then determines the perturbation signal based on the maximum frequency domain mirror index, and eliminates the perturbation signal to obtain the perturbation elimination signal, thereby improving the accuracy of vibration measurement and realizing the evaluation and elimination of camera perturbation effects. This application quantitatively evaluates the perturbation effect by determining the frequency domain mirror index, thereby determining the part of the vibration time history signal with severe perturbation effects, and eliminating the part, thereby obtaining an accurate vibration time history signal, improving the accuracy of vibration measurement, and realizing the evaluation and elimination of camera perturbation effects.

Based on the on embodiment of the camera perturbation effect evaluation and elimination device mentioned above in the present application, the other embodiment of the camera perturbation effect evaluation and elimination device of the present application is provided.

In an embodiment, the camera perturbation effect evaluation and elimination device also includes a normalized signal submodule, the normalization signal submodule includes: a normalized video unit, configured to perform initialization processing on the signal to be processed to obtain an initialization signal; a frame division unit, configured to frame the normalized video to obtain a frame set; a moving unit, configured to move a preset normalized template on each frame of the frame set according to a first preset rule, and determine a similarity matrix according to a mapping value of each moving position to obtain a plurality of similarity matrices; a reconstruction unit, configured to reconstruct each similarity matrix in the plurality of similarity matrices to obtain a reconstructed matrix set; a maximum value acquisition unit, configured to obtain a maximum value corresponding to each reconstructed matrix in the reconstructed matrix set to obtain a maximum value set; and a target signal acquisition unit, configured to obtain a number of frames of the frame set, determine a vibration time history signal according to the number of frames in the frame set and the maximum value set, and use the vibration time history signal as the signal to be processed.

In an embodiment, the camera perturbation effect evaluation and elimination device also includes a preferred reconstruction submodule, the preferred reconstruction submodule includes: an eigenfunction unit, configured to obtain eigenfunctions corresponding to the plurality of second signal sets; a preferred determination unit, configured to determine corresponding eigenfunction preferred values and preferred values of the preset parameters according to the eigenfunctions and preset parameters; and a preferred reconstruction unit, configured to in response to that the preferred values of the preset parameters meet a preset iteration stop criteria, reconstruct the corresponding eigenfunction preferred values to obtain a plurality of optimized reconstructed spectrum sets corresponding to the plurality of second signal sets.

The preferred determination unit includes: a parameter classification subunit, configured to divide the preset parameters into eigenfrequency and regularization parameters; an optimization construction subunit, configured to construct an optimization formula according to the eigenfunction, the eigenfrequency and the regularization parameters:

$$min {\sum }_{k = 1}^{K} \frac{{α}_{k}}{2} {‖ x ( t ) - {\sum }_{k = 1}^{K} {u}_{k} ( t ) {e}^{{iω}_{k} t} ‖}^{2} ,$$

where uₖ(t) is the Kth eigenfunction, ωₖ is the Kth eigenfrequency, αₖ(t) is the Kth regularization parameter, t is time, K is the number of eigenfunctions, and x(t) is the signal to be processed; a frequency optimization subunit configured to fix the eigenfunction and the regularization parameter, and calculate a partial derivative of the eigenfrequency according to the optimization formula to obtain an optimal value of the eigenfrequency; a function optimization subunit configured to fix the regularization parameter and the eigenfrequency, calculate a partial derivative of the eigenfunction according to the optimization formula to obtain an optimal value of the eigenfunction, and update the optimal value of the eigenfunction to the optimization formula; and a parameter optimization subunit configured to fix the eigenfunction and the eigenfrequency, and calculate a partial derivative of the regularization parameter according to the optimization formula to obtain an optimal value of the regularization parameter.

This embodiment generates a plurality of second signal sets by decomposing the signal to be processed and then eliminating them one by one, obtains a plurality of frequency domain mirror indexes based on the curve information obtained after frequency domain analysis of the plurality of second signal sets, determines the perturbation signal based on the maximum frequency domain mirror index, and eliminates the perturbation signal to obtain the perturbation elimination signal, thereby improving the accuracy of vibration measurement and realizing the evaluation and elimination of camera perturbation effects. The present application quantitatively evaluates the perturbation effect by determining the frequency domain mirror index, thereby determining the part with serious perturbation effect in the vibration time history signal, and eliminating the part, thereby obtaining an accurate vibration time history signal, improving the accuracy of vibration measurement, and realizing the evaluation and elimination of camera perturbation effects.

Other embodiments or specific implementation methods of the camera perturbation effect evaluation and elimination device of the present application can refer to the above-mentioned method embodiments, which will not be repeated here.

Through the description of the above implementation methods, those skilled in the art can clearly understand that the above-mentioned embodiment method can be implemented by software plus the necessary general hardware platform, of course, it can also be implemented by hardware, but in many cases the former is a better implementation method. Based on this understanding, the technical solution of the present application, or the part that contributes to the prior art, can be embodied in the form of a software product. The computer software product is stored in a storage medium (such as a read-only memory/random access memory, a disk, or an optical disk), and includes several instructions for enabling a terminal device (which can be a mobile phone, a computer, a server, an air conditioner, or a network device, etc.) to execute the methods described in each embodiment of the present application.

The above are only optional embodiments of the present application, and do not limit the scope of the present application. Any equivalent structure or equivalent process transformation made using the contents of the specification and drawings of the present application, or directly or indirectly used in other related technical fields, are also included in the scope of the present application.

What is claimed is:

1. A camera perturbation effect evaluation and elimination method, comprising:
decomposing a signal to be processed to obtain a first signal set, wherein the signal to be processed is a signal obtained by analyzing a video captured by a camera;
selecting a different signal from the first signal set each time for elimination to obtain a plurality of second signal sets;
performing frequency domain analysis on the plurality of second signal sets to obtain a curve information set;
determining a frequency domain mirror index set based on curve information in the curve information set and a mirror index formula, wherein the frequency domain mirror index set comprises a plurality of frequency domain mirror indexes, and each of the plurality of frequency domain mirror indexes corresponds to a signal eliminated from the first signal set; and
determining a maximum frequency domain mirror index from the plurality of frequency domain mirror indexes, determining a perturbation signal in the signal to be processed according to the maximum frequency domain mirror index, and eliminating the perturbation signal to obtain a perturbation elimination signal.

2. The camera perturbation effect evaluation and elimination method of claim 1, wherein before the decomposing the signal to be processed to obtain the first signal set, the method further comprises:
performing normalization processing on the video captured by the camera to obtain a normalized video;
framing the normalized video to obtain a frame set;
moving a preset normalized template on each frame of the frame set according to a first preset rule, and determining a similarity matrix according to a mapping value of each moving position to obtain a plurality of similarity matrices;
reconstructing each similarity matrix in the plurality of similarity matrices to obtain a reconstructed matrix set;
obtaining a maximum value corresponding to each reconstructed matrix in the reconstructed matrix set to obtain a maximum value set; and
obtaining a number of frames of the frame set, determining a vibration time history signal according to the number of frames in the frame set and the maximum value set, and configuring the vibration time history signal as the signal to be processed.

3. The camera perturbation effect evaluation and elimination method of claim 2, wherein the normalization refers to a process of transforming a dimensional expression into a dimensionless expression and becoming a scalar.

4. The camera perturbation effect evaluation and elimination method of claim 2, wherein the first preset rule is to move from a vertex of each frame and clinging to the frame in either a clockwise or counterclockwise direction until the entire frame is traversed.

5. The camera perturbation effect evaluation and elimination method of claim 2, wherein a distance of each movement is one pixel, and the mapping value is a value of a position on the frame after each movement.

6. The camera perturbation effect evaluation and elimination method of claim 1, wherein the decomposing the signal to be processed to obtain the first signal set comprises:
performing initialization processing on the signal to be processed to obtain an initialization signal;
eliminating a direct current high-frequency signal in the initialization signal to obtain a preliminary signal; and
decomposing the preliminary signal according to a preset number of layers to obtain the first signal set.

7. The camera perturbation effect evaluation and elimination method of claim 6, wherein the initialization processing refers to decomposing the signal to be processed into multi-order modal signals and multi-order modal frequencies.

8. The camera perturbation effect evaluation and elimination method of claim 1, wherein before the performing frequency domain analysis on the plurality of second signal sets to obtain the curve information set, the method further comprises:
obtaining eigenfunctions corresponding to the plurality of second signal sets;
determining corresponding eigenfunction preferred values and preferred values of the preset parameters according to the eigenfunctions and preset parameters; and
in response to that the preferred values of the preset parameters meet a preset iteration stop criteria, reconstructing the corresponding eigenfunction preferred values to obtain a plurality of optimized reconstructed spectrum sets corresponding to the plurality of second signal sets.

9. The camera perturbation effect evaluation and elimination method of claim 1, wherein before the decomposing the signal to be processed to obtain the first signal set, the method further comprises:
performing displacement time history analysis on a measured object in a captured video after obtaining the video captured by the camera, and configuring a analysis result as the signal to be processed.

10. The camera perturbation effect evaluation and elimination method of claim 9, wherein, before the decomposing the signal to be processed to obtain the first signal set, the method further comprises:
constructing an abnormal time course signal discrimination model trained by a large number of vibration time course signals, using the abnormal time course signal discrimination model to discriminate the signal to be processed, and eliminating abnormally the signal to be processed according to a processing result.

11. The camera perturbation effect evaluation and elimination method of claim 1, wherein the performing frequency domain analysis on the plurality of second signal sets to obtain the curve information set by the following formula:
$$f ( i ) = {\sum }_{t = 0}^{N - 1} x ( t ) {e}^{- i \frac{2 π}{N} k t}$$
where x(t) is a vibration time history signal of the tth time domain discrete point, i is a frequency domain discrete point signal corresponding to t, N is a time domain length of the signal, and f(k) is a frequency domain vector of a structural vibration time history signal.

12. The camera perturbation effect evaluation and elimination method of claim 1, wherein the mirror index formula in the step of determining the frequency domain mirror index set based on the curve information in the curve information set and the mirror index formula is as follows:
$${K}_{k} = ( \frac{\vert {f}^{″} ( i ) \vert \cdot \vert {F}^{″} ( i ) \vert}{{( 1 + {( {f}^{′} ( i ) )}^{2} )}^{3 / 2} \cdot {( 1 + {( {F}^{′} ( i ) )}^{2} )}^{3 / 2}} \cdot \frac{{σ}_{f} {σ}_{F}}{[ f ( i ) - \overline{f ( i )} ] [ F ( i ) - \overline{F ( i )} ]} ) \times \sqrt{\frac{{\sum }_{i = 1}^{n} ( f ( i ) - F ( i ) )}{{\sum }_{i = 1}^{n} {( F ( i ) )}^{2}}} ,$$
where • represents vector dot multiplication, |•| represents absolute value operation, and X represents multiplication numerical operation; σ_{f} and σ_{F} represent a standard deviation of f(i) and a standard deviation of F(i) respectively; f̅(̅l̅)̅ and F̅(̅l̅)̅ represent average values of f(i) and F(i) respectively, and Kk represents a frequency domain image index for eliminating the k-th order modal signal.

13. The camera perturbation effect evaluation and elimination method of claim 12, wherein the curve information comprises a curve amplitude, a curve shape and a curvature radius of a curve.

14. The camera perturbation effect evaluation and elimination method of claim 8, wherein the determining the corresponding eigenfunction preferred values and the preferred values of the preset parameters according to the eigenfunctions and the preset parameters comprises:
dividing the preset parameters into an eigenfrequency and a regularization parameter;
constructing an optimization formula according to the eigenfunction, the eigenfrequency and the regularization parameter, wherein the optimization formula is as follows:
$$min {\sum }_{k = 1}^{K} \frac{{α}_{k}}{2} {‖ x ( t ) - {\sum }_{k = 1}^{K} {u}_{k} ( t ) {e}^{{iω}_{k} t} ‖}^{2} ,$$
where uₖ(t) is a kth eigenfunction, ωₖ is a kth eigenfrequency, αₖ is a kth regularization parameter, t is time, K is the number of eigenfunctions, and x(t) is the signal to be processed;
fixing the eigenfunction and the regularization parameter, and taking a partial derivative of the eigenfrequency according to the optimization formula to obtain an optimal value of the eigenfrequency;
fixing the regularization parameter and the eigenfrequency, taking a partial derivative of the eigenfunction according to the optimization formula to obtain an optimal value of the eigenfunction, and updating the optimal value of the eigenfunction to the optimization formula; and
fixing the eigenfunction and the eigenfrequency, and taking a partial derivative of the regularization parameter according to the optimization formula to obtain an optimal value of the regularization parameter.

15. The camera perturbation effect evaluation and elimination method of claim 1, wherein the determining the frequency domain mirror index set based on the curve information in the curve information set and the mirror index formula comprises:
obtaining an acceleration signal collected by an accelerometer, wherein the accelerometer is provided on the object captured by the camera;
performing frequency conversion on the acceleration signal to obtain a reference signal;
obtaining a plurality of frequency domain mirror signals based on the curve information in the curve information set;
calculating a first-order derivative and a second-order derivative of the frequency domain mirror signal and the reference signal respectively to obtain a derivative calculation result set; and
obtaining a frequency domain mirror index set based on the derivative calculation result set and the mirror index formula.

16. The camera perturbation effect evaluation and elimination method of claim 1, wherein the determining the maximum frequency domain mirror index from the plurality of frequency domain mirror indexes, determining the perturbation signal in the signal to be processed according to the maximum frequency domain mirror index, and eliminating the perturbation signal to obtain the perturbation elimination signal, comprises:
performing comparative calculation on the plurality of frequency domain mirror indexes in the frequency domain mirror index set to obtain a maximum value in the frequency domain mirror index set, and configuring the maximum value in the frequency domain mirror index set as the maximum frequency domain mirror index;
determining a signal corresponding to the maximum frequency domain mirror index eliminated from the first signal set according to the maximum frequency domain mirror index, and configuring the signal corresponding to the maximum frequency domain mirror index eliminated from the first signal set as an elimination signal;
determining a perturbation signal in the signal to be processed according to the elimination signal and a preset order data; and
eliminating the perturbation signal in the signal to be processed to obtain the perturbation elimination signal.

17. The camera perturbation effect evaluation and elimination method of claim 16, wherein the preset order data does not exceed a order of the signal to be processed.

18. The camera perturbation effect evaluation and elimination method of claim 16, wherein the eliminating the perturbation signal in the signal to be processed to obtain the perturbation elimination signal according to the following formula:
$${x}^{′} ( t ) \approx x ( t ) - \sum {u}_{s} ( t ) {e}^{i ω s t} ,$$
where x′(t) is a perturbation elimination signal to be obtained, x(t) is the signal to be processed, uₛ(t) is a signal corresponding to the maximum frequency domain image index, s is a preset order data, and t is a time.

19. A camera perturbation effect evaluation and elimination device comprising a memory and a processor, wherein a computer program is stored in the memory, and when the computer program is executed by the processor, the camera perturbation effect evaluation and elimination method of claim 1 is implemented.

20. A non-transitory computer-readable storage medium, wherein a non-transitory computer program is stored in the computer-readable storage medium, and when the computer program is executed by a processor, the camera perturbation effect evaluation and elimination method of claim 1 is implemented.
